(19) United States
(12) Patent Application Publication
(10) Pub. No.: US 2008/0210036 A1
(43) Pub. Date: Sep. 4, 2008

(54) Right-Angle Multiple-Stage Reduction Unit

(75) Inventor: Giorgio Casarotto, Piacenza D'adige (IT)

Correspondence Address: RATNERPRESTIA, P O BOX 980, VALLEY FORGE, PA, 19482-0980, US

(73) Assignee: PIV POSIPLAN S.r.l. a socio unico, Piacenzab D'Adige (IT)

(21) Appl. No.: 11/913,465

(22) PCT Filed: Apr. 28, 2006
(86) PCT No.: PCT/IT2006/000300

§ 371 Date: Nov. 2, 2007

(30) Foreign Application Priority Data
May 2, 2005 (IT) PD2005A000121

(51) Int. Cl. F16H 1/20; F16H 37/06

(52) U.S. Cl. 74/417

(57) ABSTRACT

A right-angle multiple-stage reduction unit including a reduction unit box, a drive input shaft extending in the box along a first axis and having axially opposing first and second ends, a first reduction stage with a gear keyed on the drive input shaft in the proximity of its first end, at least a second reduction stage with a drive output shaft extending in the box along a second axis lying in a plane orthogonal to the first axis and intermediate between the ends of the drive input shaft, so that the first reduction stage is located on the opposite side of the plane from the second end. The drive input shaft is supported in the box between the gear and the plane with a first support positioned behind the gear.

### TECHNICAL FIELD

The present invention relates to a right-angle multiple-stage reduction unit of the type including the characteristics mentioned in the precharacterizing clause of the principal claim.

### TECHNOLOGICAL BACKGROUND

A reduction unit including these characteristics is known from EP0666969. This type of reduction unit has some advantages with respect to the known right-angle reduction units, including a greater versatility of application combined with the possibility of producing doubly protruding drive input shafts, in other words shafts having operational extensions at both of the axially opposing ends. This makes it possible to couple a plurality of reduction units in series, operated by a single drive but each provided with its own drive output.

However, these reduction units have certain drawbacks which the present invention proposes to overcome. One of these drawbacks arises from the fact that, for high power, the drive input shaft is subject to flexion which may adversely affect the operation of the reduction unit. On the other hand, the provision of intermediate supports on this shaft introduces statically indeterminate constraints which are potentially even more damaging.

It has also been found that there is a market for a reduction unit having a variety of different couplings and/or arrangements of the drive input shaft. However, the currently available structure of these reduction units does not provide adequate versatility, since it is necessary to manufacture and/or hold stocks of reduction units and/or corresponding components which differ from each other simply in the construction of the drive input shaft.

### DESCRIPTION OF THE INVENTION

The object of the invention is to provide a right-angle reduction unit which is structurally and functionally designed to overcome all the drawbacks mentioned with respect to the aforesaid prior art.

This object is achieved by the invention with a right-angle multiple-stage reduction unit constructed in accordance with the following claims.

### BRIEF DESCRIPTION OF THE DRAWINGS

The characteristics and advantages of the invention will be made clearer by the detailed description of some preferred, but not exclusive, embodiments of the invention, illustrated for guidance and without restrictive intent in the attached drawings, in which:

FIG. 1 is a schematic sectional view of a first example of embodiment of the reduction unit according to the invention;

FIG. 2 is a similar schematic sectional view of a second example of embodiment of the reduction unit of this invention;

FIGS. 3 to 5 are schematic views of different versions of a single detail of the reduction unit of FIG. 2;

FIG. 6 is a front elevation of the reduction unit of FIG. 1.

### PREFERRED EMBODIMENT OF THE INVENTION

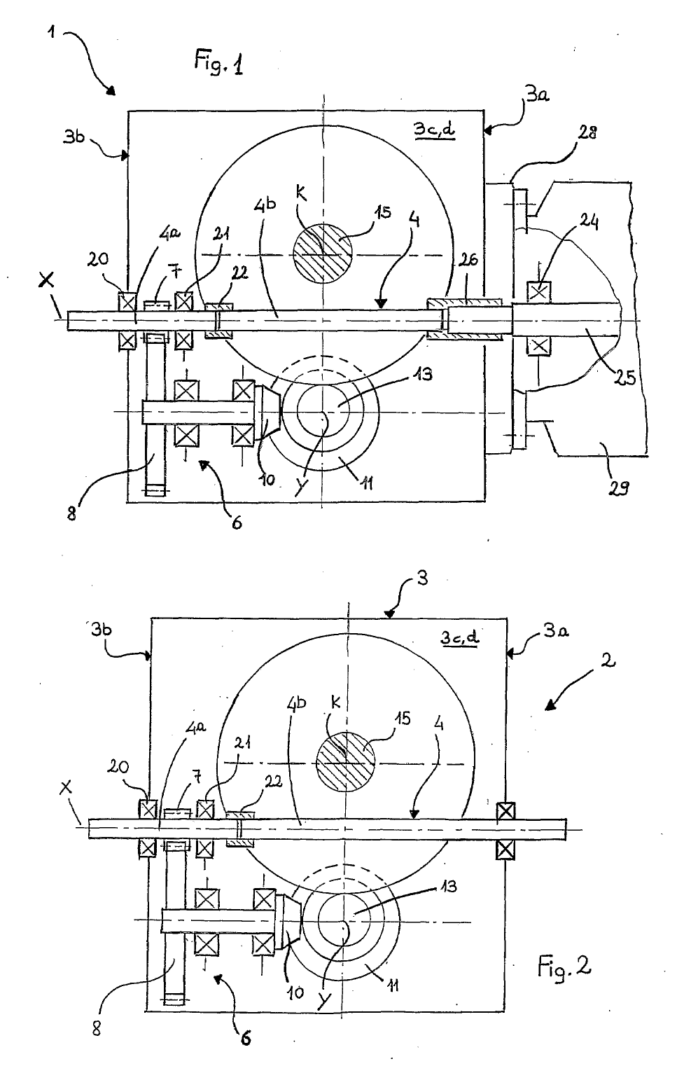

In FIGS. 1 and 2, the numerals 1 and 2 respectively indicate a right-angle multiple-stage reduction unit made according to this invention. Identical details in the two examples are identified by the same reference numerals.

Each of the reduction units 1 and 2 comprises a reduction unit box 3 with opposing walls 3a, b and 3c, d. A drive input shaft is indicated as a whole by 4. The shaft 4 is made in two portions 4a, b and extends in the box 3 along a first axis X perpendicular to the walls 3a, b. The shaft 4 has a first and a second end which are axially opposed and supplies the drive at the input of the reduction unit 1, 2 to a first reduction stage indicated as a whole by 6. The reduction stage 6 has parallel shafts with cylindrical gears and comprises a first gear 7 keyed on—or preferably made in one piece with—the portion 4a of the drive input shaft 4 at its first end, and a second gear 8 keyed on a small shaft 9 which is fixed to a pinion 10 which in turn engages with a ring gear 11. The pinion 10 and the ring gear 11 form a right-angled drive transmission and also a second reduction stage of the reduction unit 1, 2.

A third reduction stage comprises a further pair of gears 13, 14, the first being keyed together with the ring gear 11 on a shaft with an axis Y extending perpendicularly between the walls 3c, d and supported on them, while the second is keyed on a further shaft 15 for the drive output, having an axis K parallel to the axis Y. Both the shafts with the axes Y and K are supported by bearings (not shown) in the walls 3c, d.

The drive output axes Y and K define an intermediate plane between the ends of the drive input shaft and perpendicular to the axis X. The first reduction stage 6 is on the opposite side of the said plane from the free end of the portion 4b, in other words on the opposite side from the drive input into the reduction unit 1,2.

The first portion 4a of the drive input shaft is supported in the box 3 by means of a first and a second support 20, 21. The first support 20 is formed in the wall 3b of the box 3 and the shaft 4 may or may not be made to protrude beyond it, outside the box 3. The shaft 4 can be made to protrude from the box 3 at only one end or at both of its axially opposing ends, as in the illustrated example. The second support 21 is formed inside the box 3, in a position behind the gear 7, on one side, and behind a joint 22 on the other side. The joint 22 joins the portions and allows them to rotate with respect to each other, thus providing the minimum play which prevents the establishment of statically indeterminate conditions.

For low installed powers and in the case of the configuration of FIG. 1, the first support 20 can be omitted.

In the example 1 of FIG. 1, the second portion 4b of the drive input shaft 4 is supported in the box by the supports 24 of the shaft 25 of an electric motor 29 whose casing 27 is mounted on the box 3, for example by means of a flanged connector 28. The shaft 25 is fixed to the drive input shaft 4 by means of a joint 26 or other similar coupling.

Thus a considerable compactness of the reduction unit is achieved, since the shaft 25 of the motor is at least partially housed inside the box 3. This also makes it unnecessary to provide a separate support for the second portion 4b of the drive input shaft 4. Thus an optimal coupling of the motor to the reduction unit is obtained, in which problems of alignment of the shafts 4 and 25 are easily overcome.

According to another characteristic of the invention, the drive input shaft 4 lies in a substantially median position in the box 3, at least with reference to the walls 3c, d perpendicular to the axes Y and K (FIG. 6). This facilitates the arrangement of a plurality of reduction units in series as mentioned above, these units being aligned independently of the arrangement of the corresponding drive inputs.

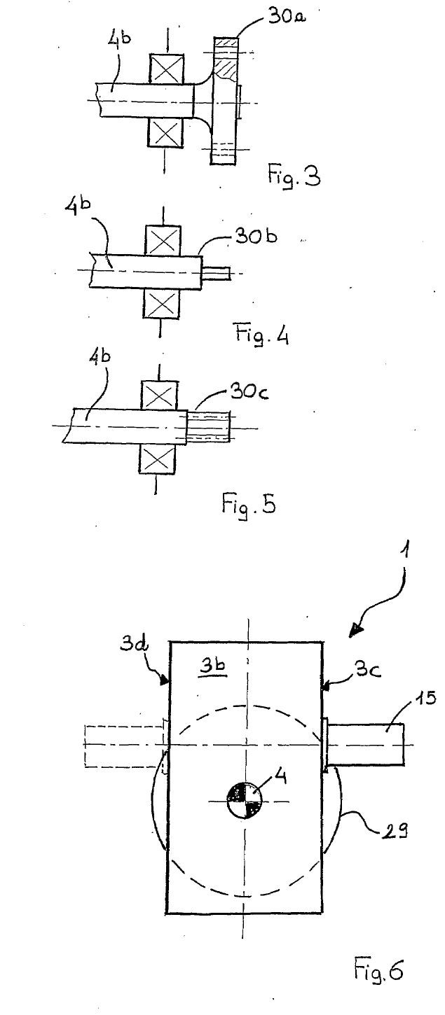

Finally, as shown in FIGS. 3 to 5, the invention makes it possible to construct reduction units in which the first portion 4a is standardized while the second portion 4b is manufactured according to the customer's requirements, with coupling ends 30a, b, c which differ from each other (for example flanged couplings, key couplings, grooved profile couplings, etc.). Depending on the demand at any time, the reduction unit can be completed with a second portion provided with the appropriate coupling end to meet the customer's requirements.

The principal advantages of the invention include:
improved machinability and strength of the drive input shaft;
a lower storage requirement for different components;
greater compactness of the combined motor and reduction unit version.

1. Right-angle multiple-stage reduction unit including:
a reduction unit box,
a drive input shaft extending in the box along a first axis and having axially opposing first and second ends,
a first reduction stage with a gear keyed on the drive input shaft in the proximity of its first end,
at least a second reduction stage with a drive output shaft extending in the box along a second axis lying in a plane orthogonal to the first axis and intermediate between the ends of the drive input shaft in such a way that the first reduction stage is located on an opposite side of the plane from the second end,
drive input shaft being supported in the box between the gear and the plane by a first support positioned behind the gear, wherein the drive input shaft is supported in the box at the second end by means of the supports of a motor which has its shaft fixed to the drive input shaft, forming an extension of the latter, and which is mounted on the box.

2. Right-angle multiple-stage reduction unit including:
a reduction unit box,
a drive input shaft extending in the box along a first axis and having axially opposing first and second ends,
a first reduction stage with a gear keyed on the drive input shaft in the proximity of its first end,
at least a second reduction stage with a drive output shaft extending in the box along a second axis lying in a plane orthogonal to the first axis and intermediate between the ends of the drive input shaft in such a way that the first reduction stage is located on an opposite side of the plane from the second end,
the drive input shaft being supported in the box between the said and the said plane by a first support positioned behind the said gear, wherein the said drive input shaft comprises two portions joined by a joint, the first portion carrying the said gear and being supported by a first and a second support, the said supports being positioned on respective sides of the said gear.

3. The reduction unit according to claim 1, in which the drive input shaft comprises two portions joined by a joint, the first portion carrying the gear and being supported by a first and a second support, the supports being positioned on respective sides of the gear.

4. The reduction unit according to claim 1, in which the second portion of the drive input shaft is connected to the shaft of the motor.

5. The reduction unit according to claim 1, in which the drive input shaft is supported, at both of its opposing ends, on opposing walls of the box.

6. The reduction unit according to claim 5, in which the drive input shaft is doubly protruding from the said box, in other words protrudes beyond each of the opposing walls.

7. The reduction unit according to claim 5, in which the drive input shaft plies in a substantially median position in the box.

8. The reduction unit according to claim 2, in which the drive input shaft is supported, at both of its opposing ends, on opposing walls of the box.

9. The reduction unit according to claim 8, in which the drive input shaft is doubly protruding from the box, and thereby protrudes beyond each of the opposing walls.

10. The reduction unit according to claim 8, in which the drive input shaft lies in a substantially median position in the box.

11. The reduction unit according to claim 3, in which the second portion of the drive input shaft is connected to the shaft of the said motor.
